(19) United States
(12) Patent Application Publication
(10) Pub. No.: US 2021/0410232 A1
(43) Pub. Date: Dec. 30, 2021

(54) ELECTRIC HEATING DEVICE AND METHOD

(71) Applicant: Mahle International GmbH, Stuttgart (DE)

(72) Inventors: Michael Kohl, Bietigheim-Bissingen (DE); Peter Schluenzen, Stuttgart (DE); Wolfgang Seewald, Tamm (DE); Falk Viehrig, Stuttgart (DE); Denis Wiedmann, Fellbach (DE)

(21) Appl. No.: 17/361,287

(22) Filed: Jun. 28, 2021

(30) Foreign Application Priority Data
Jun. 29, 2020 (DE) 10 2020 208 015.1

(51) Int. Cl. H05B 3/26

(52) U.S. Cl. CPC H05B 3/26

(57) ABSTRACT

An electric heating device for heating a temperature-control fluid may include two electrodes, a heating element, and an elevation. The two electrodes may each include an electrode body with an inner surface. The heating element may include two electrical connecting surfaces disposed opposite one another. The heating element may be arranged between the two electrodes such that each connecting surface faces the inner surface of a respective one of the two electrodes. A joint may be delimited by the inner surface of an electrode and the associated connecting surface of the heating element. The joint may be filled with an adhesive via which the electrode is connected to the heating element in an integrally bonded manner. The elevation may project into the joint from the inner surface delimiting the joint. The elevation may lie against the associated connecting surface and electrically connect the electrode to the associated connecting surface.

### CROSS-REFERENCE TO RELATED APPLICATIONS

This application claims priority to German Patent Application No. DE 10 2020 208 015.1, filed on Jun. 29, 2020, the contents of which is hereby incorporated by reference in its entirety.

### TECHNICAL FIELD

The invention relates to an electric heating device for heating a temperature-control fluid, in particular for a motor vehicle, and to a method for producing such a heating device.

### BACKGROUND

In particular in motor vehicles with a hybrid drive or in vehicles that are purely driven electrically, electric heating devices by means of which heat can be supplied to a vehicle interior have been employed for some time. By means of such an electric heating device, a temperature-control fluid is usually heated, i.e. charged with heat. The temperature-control fluid can be air, which, after it has been charged with heat by means of the electric heating device, is fed to the vehicle interior. Alternatively, the temperature-control fluid can be a temperature-control liquid which circulates in a fluid circuit. The electric heating device is then arranged in this fluid circuit so that by means of the electric heating device the temperature-control liquid can be charged with heat. Apart from this, a heat exchanger is typically present in the fluid circuit by means of which the heat carried along by the temperature-control liquid can be passed on to the air that is present in the vehicle interior.

For realizing an overheating protection, electric heating devices are usually embodied with PTC heating elements, by means of which electric energy can be converted into heat. Such PTC heating elements usually comprise or are PTC thermistors of ceramic and have a greatly temperature-dependent electrical resistance, which greatly increases with increasing temperature of the ceramic element. Because of this, a substantially constant temperature materializes on the PTC heating element independently of an applied electrical voltage, an electrical nominal resistance, a quantity of discharged heat, etc. Thus, this temperature is always approximately the same, wherein a heating output of the PTC heating element automatically adapts or adjusts to peripheral conditions listed above.

In conventional electric heating devices, the heating elements are arranged between two electrodes, by means of which the heating elements are suppliable with electric energy. Usually, these two electrodes each contact one of two electrical connecting surfaces of the heating elements over a full surface area. This means that in conventional electric heating devices a distance of the electrodes is determined by a thickness of the heating elements.

However, since between the two electrodes of the electric heating device typically multiple heating elements are arranged next to one another, this creates the disadvantage that—in order to ensure a reliable electrical contacting between the heating elements and the electrodes—a thickness of the individual heating elements has to be realized with very small tolerances. Otherwise, a gap can be created between heating elements formed thinner and one of the electrodes, which worsens or even renders impossible a reliable electrical contacting of the heating element and of the electrode.

### SUMMARY

It is therefore an object of the present invention—in particular for eliminating the aforementioned disadvantage—to show new ways for electric heating devices and for methods for producing such an electric heating device.

In an electric heating device, the basic idea accordingly is to glue at least one of two electrodes to at least one heating element of the electric heating device, wherein between the heating element and the electrode glued to this heating element, a joint filled with adhesive is provided, into which at least one elevation included by the electrode projects, which, electrically bridging the joint, is electrically connected to the heating element.

Advantageously it is thereby achieved that by means of the adhesive on the one hand a reliable fastening of the heating element and of the electrode to one another is achieved, wherein on the other hand a good thermal connection of the heating element to the electrode is simultaneously ensured by means of the adhesive. Here, the elevation of the electrode projecting through the joint ensures a reliable physical electrical contact of the electrode to the heating element, which advantageously is retained even in particular when the heating element or the electrode are subjected to a dimensional change relative to one another due to temperature.

An electric heating device according to the invention serves for heating a temperature-control fluid which can be liquid or gaseous. The electric heating device is preferentially employable for a motor vehicle. The electric heating device comprises two electrodes of which each comprises an electrode body with an inner surface. Apart from this, the electric heating device comprises at least one electric heating element which comprises two electrical connecting surfaces located opposite one another. The electric heating element is arranged between the electrodes so that an electrical connecting surface of the inner surface each faces one of the electrodes. Here, a joint is present between at least one electrode and the heating element which is delimited by the inner surface of the electrode concerned and the associated connecting surface. This joint is filled with an adhesive, by means of which the electrode is connected to the heating element in an integrally bonded manner. From the inner surface delimiting the joint, an elevation projects from the electrode body of the electrode concerned into the joint. Practically, the elevation and the electrode body are formed material-uniformly on one another. For electrically bridging the joint, the said elevation lies against the associated connecting surface of the heating element. Here, the connecting surface in particular does not directly lie against the associated inner surface. The elevation lies against the associated connecting surface in such a manner that the electrode comprising the connecting surface is electrically connected to the associated connecting surface by means of its at least one elevation. As already indicated above, it is thereby advantageously achieved that by means of the adhesive a reliable fastening of the electrode and of the heating element on one another can be achieved and by means of the elevation of the electrode a robust physical electrical connection of the electrode to the heating element can be ensured.

According to a preferred further development of the electric heating device, a joint is present between each of the two electrodes and the heating element, which joint is delimited by the inner surface of the respective electrode and one of the connecting surfaces and which is filled with an adhesive. By means of the adhesive, both of the electrodes are each connected to the heating element in an integrally bonded manner. On the inner surfaces of the two electrodes delimiting the joints, at least one elevation each is present, which projects from the electrode body of the electrode concerned in the direction of the respective associated connecting surface of the heating element. For the electrical bridging of one of the two joints, these elevations each lie against one of the two connecting surfaces. The elevations lie against the connecting surfaces of the heating element in such a manner that both electrodes, by means of their respective at least one elevation, are electrically connected to the associated connecting surfaces. Consequently it can be advantageously ensured that the heating element is particularly reliably electrically connected to both electrodes and at the same time a secure fastening of the electrodes and of the heating element on one another can be achieved.

Practically, the heating element comprises a PTC resistor or is such a PTC resistor. Such a PTC resistor offers the advantage that it adjusts its heating output substantially independently of any peripheral conditions, as a result of which an overheating protection can be particularly easily realized.

According to a further preferred further development of the electric heating device, the elevation is deformable, so that tolerance-induced dimensional deviations and temperature-induced dimensional changes of the electrodes comprising the elevation and alternatively or additionally of the heating element are offsetable by means of a deformation of the elevation. Preferentially, the elevations are elastically and/or plastically deformable and the dimensional deviations or dimensional changes offsetable by means of an elastic and/or plastic deformation of the elevation. This offers the advantage that the heating element, during its production, can be subjected to greater tolerances which basically has a cost-lowering effect on the production of the heating element, since less precise manufacturing and quality assurance processes can be employed without jeopardizing a functionality of the electric heating device.

In a further preferred further development of the electric heating device, the inner surface of the electrode with elevation runs in a basic plane of the electrode. There, a height of the elevation measured perpendicularly to the inner surface or to the basic plane determines an offset of an electrical connecting plane which substantially runs parallel to the basic plane. The said offset is preferentially greater than zero. An electrical contact between electrode and heating element or between elevation and connecting surface is, preferentially exclusively, present in the electrical connecting plane. Advantageously, a defined electrical contact between the electrode and the heating element can thus be ensured over an entire lifespan of the electric heating device.

Practically, the heating element is thermally coupled to the electrode by means of the adhesive. This allows a particularly good transfer of the heat generated by means of the heating element to a temperature-control fluid flowing past the heating device on the outside.

Advantageously, the adhesive has a heat-conductivity of 0.1 to 5 W/(m*K). By way of this, the heat transfers to the temperature-control fluid flowing about the electric heating device on the outside can be particularly favourably realized.

Practically, the adhesive is designed so as to be electrically insulating or electrically conductive. An electrically insulating adhesive makes it possible that a transmission of electric energy from the electrode to the heating element takes place exclusively via the elevation of the electrode concerned, so that the said electrical contact can be particularly accurately fixed structurally. Compared with this, an adhesive designed so as to be electrically conductive has the advantage that a particularly large surface area of the heating element and of the electrode can be utilized for transmitting the electric energy.

According to an advantageous further development of the electric heating device, at least one elevation of the electrode electrically contacts the associated electrical connecting surface substantially in a centre of the said electrical connecting surface. This ensures an optimal function of the heating element and additionally prevents a thermal distortion as a consequence of unevenly distributed thermally induced mechanical stresses.

In a further advantageous further development of the electric heating device, multiple elevations arranged spaced apart from one another are present on the inner surface of the electrode delimiting the joint, which elevations form a structuring that is raised relative to the inner surface. By way of this, a particularly good electrical contacting of the heating element can be advantageously achieved by means of the elevations.

In a further preferred further development of the electric heating device, the structuring, in a plan view on the inner surface of the electrode comprising the elevation, is stripe-like, punctiform or cruciform in shape. Advantageously, a particularly robust formation of the electrical contact between the electrode and the heating element can thereby be achieved.

A further preferred further development of the electric heating device provides that the electrodes, facing away from their inner surfaces, each have an outer surface on which an electrical insulating layer is arranged. There, the electrodes including heating element are surrounded by a tubular body, wherein the insulating layer electrically insulates the electrodes including heating element from the tubular body. The said tubular body advantageously separates the electrodes and the heating element of the electric heating device from a temperature-control fluid flowing past the electric heating device on the outside, so that a direct contact of the electrodes or of the heating element with the temperature-control fluid is effectively avoided, which on the one hand could cause an electrical short circuit between the electrodes and on the other hand chemically attack a material of the electrodes or of the heating element.

According to a further preferred further development of the electric heating device, the heating device comprises multiple electric heating elements which are arranged between the two electrodes spaced apart from one another, so that the multiple heating elements are connected electrically parallel by means of the electrodes. This advantageously has the consequence of an increase of the heating output that is achievable or achieved.

Apart from this, the invention relates to a method for producing an electric heating device according to the invention in accordance with the above description. The method provides that two electrodes and at least one electric heating element are provided. There, on an inner surface of at least one, preferentially each, electrode an elevation that is raised relative to the inner surface and projecting from the electrode body of this electrode is created. This creating of the elevation is performed by means of a laser or by machining or depositing or eroding or forming or punching, or a combination thereof. The electrode provided with the elevation is glued to the heating element so that between the electrode and the heating element a joint is created. This joint is delimited by the inner surface of the electrode concerned and an electrical connecting surface of the heating element. According to the method, the joint is filled with an adhesive which connects the electrode and the heating element to one another in an integrally bonded manner. Furthermore, the joint is electrically bridged by means of the elevation so that the electrode with elevation is electrically connected to this connecting surface of the heating element by its elevation lying against the associated connecting surface of the heating element. The advantages of the electric heating device according to the invention shown above analogously apply also to the method according to the invention for producing such an electric heating device.

Further important features and advantages of the invention are obtained from the sub-claims, from the drawings and from the associated figure description by way of the drawings.

It is to be understood that the features mentioned above and still to be explained in the following cannot only be used in the respective combination stated, but also in other combinations or by themselves without leaving the scope of the present invention.

Preferred exemplary embodiments of the invention are shown in the drawing and are explained in more detail in the following description, wherein the same reference numbers relate to same or similar or functionally same components.

### BRIEF DESCRIPTION OF THE DRAWINGS

It shows, in each case schematically:

FIG. 1 shows exemplarily an electric heating device according to the invention in a sectional representation,

FIG. 2 shows an example of an electric heating device according to the invention in a perspective representation,

FIGS. 3 through 6 show various examples of electrodes for an electric heating device according to the invention each in a sectioned representation.

### DETAILED DESCRIPTION

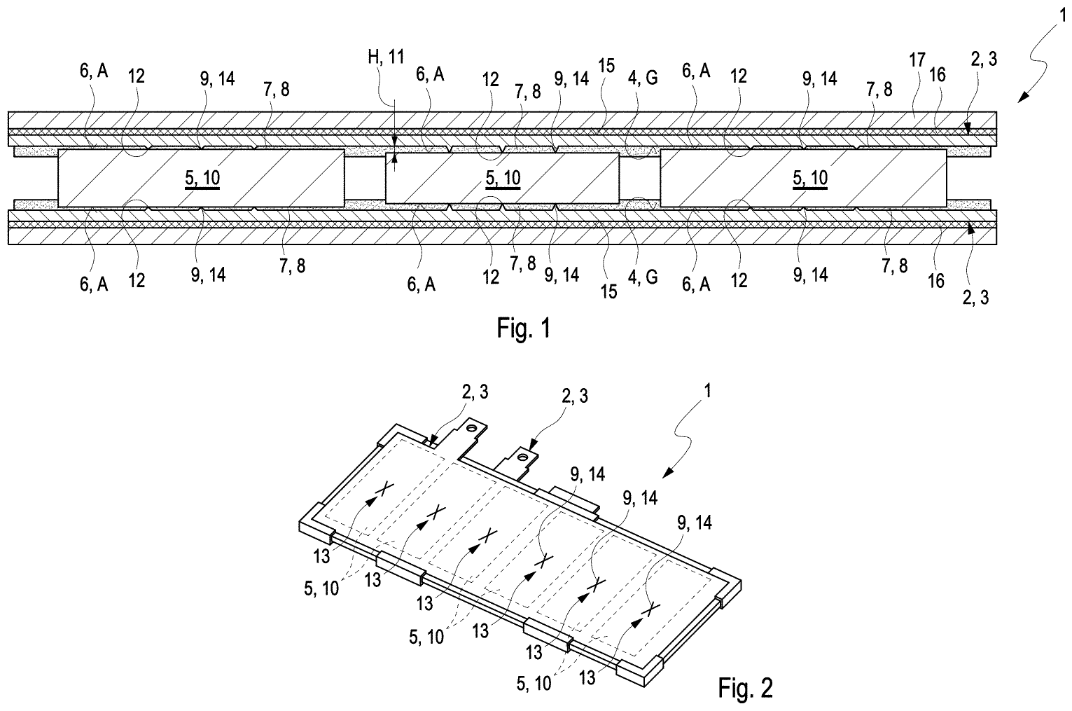

In FIG. 1, an example of an electric heating device 1 according to the invention is shown, which is employable for heating a temperature-control fluid. Such a temperature-control fluid can be a temperature-control gas, in particular air, or a temperature-control liquid. The electric heating device 1 can be employed in a motor vehicle. The electric heating device 1 comprises two electrodes 2. Each of the electrodes 2 comprises an electrode body 3, on which an inner surface 4 is present. The electric heating device 1 additionally comprises at least one heating element 5, which comprises two electrical connecting surfaces 6 located opposite one another. In the example of FIG. 1, three such heating elements 5 of the electric heating device 1 are noticeable. The electric heating device 5 is arranged between the electrodes 2 so that an electrical connecting surface 6 each faces the inner surface 4 of one of the electrodes 2. Between at least one electrode 2 and the heating element 5 a joint 7 is present, which is delimited by the inner surface 4 of the electrode 2 concerned and the associated connecting surface 6. This joint 7 is filled with an adhesive 8, by means of which the electrode 2 is connected to the heating element 5 in an integrally bonded manner. At least one elevation 9 projects from the electrode body 3 on the inner surface 4, which delimits the joint 7, into the joint 7. For electrically bridging the joint 7, the elevation 9 lies against the associated connecting surface 6 so that the electrode 2 concerned is electrically connected to the associated connecting surface 6 by means of at least one elevation 9.

In the example of FIG. 1, a joint 7 each is present between each electrode 7 and the heating element 5, which is delimited by the inner surface 4 of the respective electrode 2 and one of the connecting surfaces 6. Both these joints 7 are filled with an adhesive 8, by means of which the electrodes 2 are connected to the heating element in an integrally bonded manner. On the inner surfaces 4 of both electrodes 2 delimiting the joints 7, an elevation 9 each projecting from the electrode body 3 concerned in the direction of the respective associated connecting surface 6 is present. For the electrical bridging of the joints 4, these elevations 9 each lie against one of the two connecting surfaces 6 so that both electrodes 2 are electrically connected to the associated connecting surfaces 6 by means of their respective at least one elevation 9. The heating element 5 comprises, for example, a PTC resistor 10 or is such a PTC resistor 10.

According to FIG. 1, at least one elevation 9—in the shown example this applies to all elevations 9—is deformable. The elevation 9 is, for example, elastically or plastically deformable. The elevation 9 is deformable in such a manner that dimensional deviations due to manufacturing tolerances and temperature-induced dimensional changes of the electrode 2 or of the heating element 5 comprising the elevation 9 are offsetable by means of a deformation of the elevation 9. Accordingly it is exaggeratedly shown in FIG. 1 that the three heating elements 5 shown there have different thickness dimensions which are offset by means of the elevations 9 in such a manner that despite the dimensional deviations a solid electrical connection of the heating elements 5 to the electrodes 2 is formed.

FIG. 1 shows furthermore that the inner surface 4 of the electrode 2 with elevations 9 runs in a base surface G of the electrode 2. A height H of the elevations 9 measured perpendicularly to the inner surface 4 or to the base surface G determines an offset 11 of an electrical connecting plane A. The electrical connecting plane A substantially runs parallel to the basic plane G. An electrical contact 12 between the electrodes 2 and the heating element 5 is present in the electrical connecting plane A. The heating element 5 is thermally coupled to the electrode 2 by means of the adhesive 8. The adhesive 8 has a heat conductivity of 0.1 to 5 W/(m*K). The adhesive 8 is formed, for example, so as to be electrically insulating or electrically conductive.

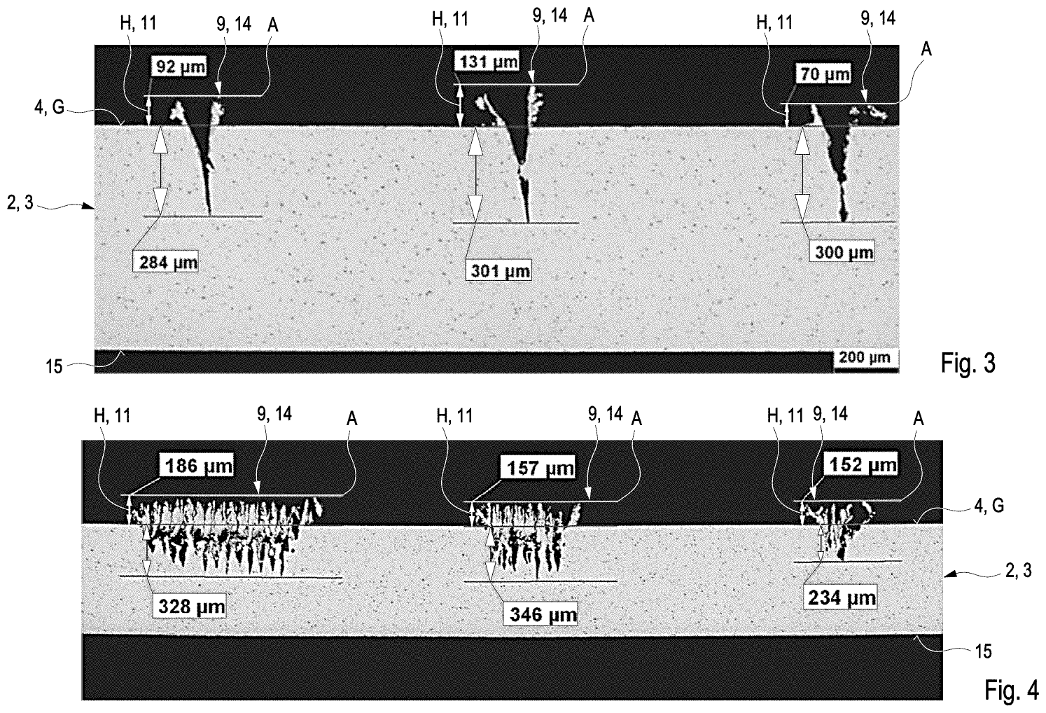

FIG. 2 shows a further example of an electric heating device 1 according to the invention in a perspective representation. Here it is evident in the FIGS. 1 and 2 that the elevation 9 electrically contacts the associated electrical connecting surface 6 in a centre 13 of this connecting surface 6. On the inner surface 4 delimiting the joint 7, multiple elevations 9 arranged spaced apart from one another are present, which form a structuring 14 that is raised relative to the inner surface 4. The structuring 14 can be cruciform in shape in a plan view of the inner surface 4 of the electrode 2 having the elevation 9—as is evident in FIG. 2. Alternatively or additionally, the structuring 14 can be stripe-like or punctiform in shape.

According to FIG. 1, the electrodes 2 each have an outer surface 15 facing away from their inner surfaces 4. On this outer surface 15 an electrical insulating layer 16 each is arranged in the shown example. The electrodes 2 are surrounded by a tubular body 17 including the heating element 5 arranged between these electrodes 2. The electrical insulating layer 16 electrically insulates the electrodes 2 including the heating elements 5 from the tubular body 17.

From the FIGS. 1 and 2 it is evident, furthermore, that the heating device 1 comprises multiple heating elements 5 which are arranged between the two electrodes 2 spaced apart from one another, so that the multiple heating elements 5 are electrically connected in parallel by means of the electrodes 2.

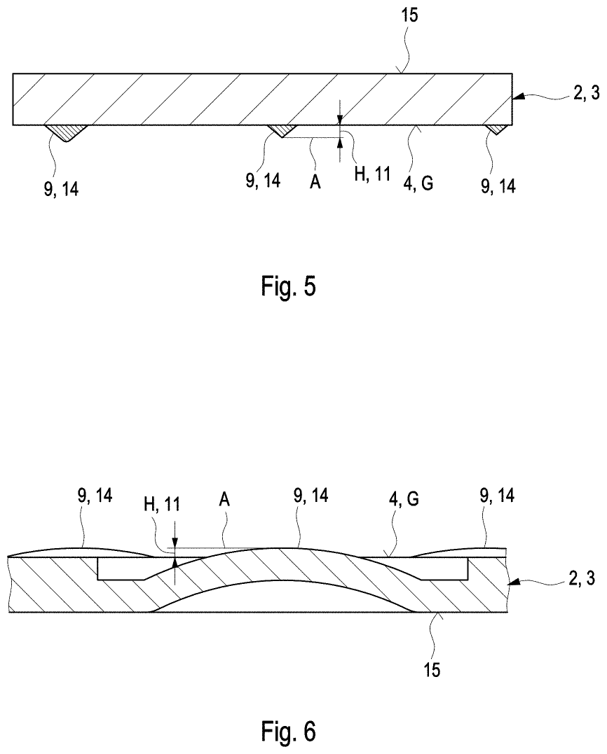

In the FIGS. 3 and 4, examples of electrodes 2 with elevations 9 for an electric heating device 1 according to the invention are shown sectioned. The elevations 9 of the examples of the FIGS. 3 and 4 are created by means of a laser. The elevations 9 created by means of the laser have a height H of 70 μm to 131 μm according to FIG. 3. According to FIG. 4, the height H of the elevations 9 amounts to 152 μm to 168 μm.

FIG. 5 shows a further sectioned example of an electrode 2 with elevations 9 for an electric heating device 1 according to the invention. In the example of FIG. 5, the elevations 9 are created by forming. Such elevations 9 created by forming can be stamped.

FIG. 6 illustrates in a sectional representation a further example of an electrode 2 for an electric heating device 1 according to the invention. The elevations 9 of the electrode 2 of FIG. 6 are created by forming. Alternatively to the examples shown in the FIGS. 3 to 6, the elevations 9 can be created by machining or depositing or eroding or punching. This means that the elevation 9 can be created by means of a laser or by machining or depositing or eroding or forming or punching, or a combination thereof.

The examples of the electric heating device 1 of the FIGS. 1 and 2 are produced by means of a method for producing an electric heating device 1 according to the invention. According to this method, two electrodes 2 and at least one heating element 5 are provided. On an inner surface 4 of at least one—in the example of FIG. 1 each—electrode 2, on elevation 9 that is raised relative to the inner surface 4 and projects from the electrode body 3 of this electrode 2 is created. Creating the elevation 9 is carried out by means of a laser or by machining or depositing or eroding or forming or punching, or a combination thereof. The electrode 2 provided with the elevation 9 is glued to the heating element 5 so that between the electrode 2 and the heating element 5 a joint 7 is created. The joint 7 so created is delimited by the inner surface 4 of the electrode 2 concerned and an electrical connecting surface 6 of the heating element 5. This joint 7 is filled with an adhesive 8, which connects the electrode 2 and the heating element 5 to one another in an integrally bonded manner. The joint 7 is electrically bridged by means of the elevation 9 so that the electrode 2 with elevation 9 is electrically connected to this connecting surface 6 in that its elevation 9 lies against the associated connecting surface 6.

1. An electric heating device (1) for heating a temperature-control fluid, in particular for a motor vehicle;
having two electrodes (2), of which each comprises an electrode body (3) with an inner surface (4),
having at least one heating element (5) which comprises two electrical connecting surfaces (6) located opposite one another and which is arranged between the electrodes (2) so that in each case an electrical connecting surface (6) faces the inner surface (4) of one of the electrodes (2),
wherein at least one electrode (2) and the heating element (5) a joint (7) is present, which is delimited by the inner surface (4) of the electrode (2) concerned and the associated connecting surface (6) and which is filled with an adhesive (8), by means of which the electrode (2) is connected to the heating element (5) in an integrally bonded manner,
wherein at least one elevation (9) projects from the inner surface (4) delimiting the joint (7) from the electrode body (3) into the joint (7), which for electrically bridging the joint (7) lies against the associated connecting surface (6), so that this electrode (2) is electrically connected to the associated connecting surface (6) by means of at least one elevation (9).

2. The electric heating device (1) according to claim 1, characterised in that
between each electrode (2) and the heating element (5) a joint (7) each is present, which is delimited by the inner surface (4) of the respective electrode (2) and one of the connecting surfaces (6) and which is filled with an adhesive (8) by means of which the electrode (2) is connected to the heating element (5) in an integrally bonded manner,
on the inner surfaces (4) of both electrodes (2) delimiting the joints (7), at least one elevation (9) projecting from their electrode bodies (3) in the direction of the respective associated connecting surface (6) is present, which for electrically bridging the joints (4) each lie against one of the connecting surfaces (6), so that both electrodes (2) are electrically connected to the associated connecting surfaces (6) by means of their respective at least one elevation (9).

3. The electric heating device (1) according to claim 1 or 2, characterized in that the heating element (5) comprises a PTC resistor (10) or is a PTC resistor (10).

4. The electric heating device (1) according to any one of the preceding claims, characterized in that the elevation (9) is elastically and/or plastically deformable, so that dimensional deviations due to manufacturing tolerances and temperature-induced dimensional changes of the electrode (2) comprising the elevation (9) and/or of the heating element (5) are offsetable by means of an elastic and/or plastic deformation of the elevation (9).

5. The electric heating device (1) according to any one of the preceding claims, characterized in that
the inner surface (4) of the electrode (2) with the elevation (9) runs in a basic plane (G) of the electrode (2),
a height (H) of the elevation (9) measured perpendicularly to the inner surface (4) or to the basic plane (G) determines an offset (11) of an electrical connecting plane (A) which substantially runs parallel to the basic plane (G),
an electrical contact (12) is present between electrode (2) and heating element (5) in the electrical connecting plane (A).

6. The electric heating device (1) according to any one of the preceding claims, characterized in that the heating element (5) is thermally coupled to the electrode (2) by means of the adhesive (8).

7. The electric heating device (1) according to any one of the preceding claims, characterized in that the adhesive (8) has a heat conductivity of 0.1 to 5 W/(m*K).

8. The heating device (1) according to any one of the preceding claims, characterized in that the adhesive (8) is electrically insulating or electrically conductive.

9. The electric heating device (1) according to any one of the preceding claims, characterized in that the elevation (9) electrically contacts the associated electrical connecting surface (9) substantially in the centre (13) of the latter.

10. The electric heating device (1) according to any one of the preceding claims, characterized in that the elevation (9) is created by means of a laser or by machining or depositing or eroding or forming or punching, or a combination thereof.

11. The electric heating device (1) according to any one of the preceding claims, characterized in that on the inner surface (4) delimiting the joint (7) multiple elevations (9) arranged spaced apart from one another are present, which form a structuring (14) that is raised relative to the inner surface (4).

12. The electric heating device (1) according to claim 11, characterized in that the structuring (14) in a plan view of the inner surface (4) of the electrode (2) comprising the elevation (9) is stripe-like, punctiform or cruciform in shape.

13. The electric heating device (1) according to any one of the preceding claims, characterized in that
the electrodes (2) facing away from their inner surfaces (4) each has an outer surface (15) on which an electrical insulating layer (16) is arranged,
the electrodes (2) including heating element (5) are surrounded by a tubular body (17), wherein the insulating layer (16) electrically insulates the electrodes (2) including heating element (5) from the tubular body (17).

14. The electric heating device (1) according to any one of the preceding claims, characterized in that the heating device (1) comprises multiple heating elements (5) which are arranged spaced apart from one another between the two electrodes (2) so that the multiple heating elements (5) are connected electrically in parallel by means of the electrodes (2).

15. A method for producing an electric heating device (1) according to any one of the preceding claims, according to which
two electrodes (2) and at least one heating element (5) are provided on an inner surface (4) of at least one, preferentially each electrode (2) an elevation (9) that is raised relative to the inner surface (4) and projecting from the electro body (3) of this electrode (2) is created,
the creating of the elevation (9) is carried out by means of a laser or by machining or depositing or eroding or forming or punching, or a combination thereof,
the electrode (2) provided with the elevation (9) is glued to the heating element (5) in such a manner that between the electrode (2) and the heating element (5) a joint (7) is created, which is delimited by the inner surface (4) of the electrode concerned (2) and an electrical connecting surface (6) of the heating element (5) and which is filled with an adhesive (8), which connects the electrode (2) and the heating element (5) to one another in an integrally bonded manner,
the joint (7) is electrically bridged by means of the elevation (9) so that the electrode (2) with elevation (9) is electrically connected to the associated connecting surface (6) in that its elevation (9) lies against the latter.
